(19) United States
(12) Patent Application Publication
(10) Pub. No.: US 2004/0024633 A1
(43) Pub. Date: Feb. 5, 2004

(54) Multi-market broadcast tracking, management and reporting method and system

(76) Inventor: Thomas J. Whymark, Bethlehem, PA (US)

Correspondence Address: SCHWEITZER CORNMAN GROSS & BONDELL LLP, 292 MADISON AVENUE - 19th FLOOR, NEW YORK, NY, 10017, US

(21) Appl. No.: 10/278,332

(22) Filed: Oct. 23, 2002

Related U.S. Application Data
(60) Provisional application No. 60/384,362, filed on May 30, 2002.

(51) Int. Cl. G06F 17/60

(52) U.S. Cl. 705/10

(57) ABSTRACT

A method of analyzing multi-market broadcasts of commercial advertisements, has unique identifiers are assigned to a plurality of expected commercial advertisements, information regarding the plurality of expected commercial advertisements and respective unique identifiers is recorded in a computer database, electronic detections of a plurality of actual market-broadcast instances of a commercial advertisement are received, which comprise a plurality of broadcast markets, information regarding the detections is recorded in a computer database, related ones of the plurality of actual market-broadcast instances of the commercial advertisement is recorded in a computer database, which comprising a plurality of broadcast markets, information regarding a plurality of multi-market broadcast orders of commercial advertisements is recorded in a computer database, and related ones of the actual market-broadcast instances of the commercial advertisement are associated with a related multi-market broadcast order for said commercial advertisement in a computer database, where the multi-market broadcast order comprises the plurality of broadcast markets.

### FIELD OF THE INVENTION

The invention pertains to the field of commercial broadcast advertising, and in particular, to confirming and reporting on fulfilled and unfulfilled broadcast advertising orders.

### BACKGROUND AND SUMMARY OF THE INVENTION

Broadcasts on commercial broadcast mediums, such as commercial radio or television airwave frequencies, cable television systems, or satellite television or satellite radio systems typically include commercial advertising interspersed within and among featured programs, such as shows, sporting events and news programs. Broadcasts are transmitted on predefined channels of broadcast mediums, however a particular broadcast may be transmitted on more than one broadcast medium at the same time. In particular, broadcast television stations, which historically transmitted solely via commercial television airwaves, are now commonly re-transmit via (i.e., are carried by) cable television systems and satellite broadcast systems as well. Further, the broadcast medium used to deliver the broadcast to a consumer may be operated by a carrier system that is independent of the originator of the broadcast—as is often the case with a broadcast from a broadcast television station delivered to consumers via a cable or a satellite television system.

The broadcasts of multi-market broadcasters, such as national television broadcast networks, national cable network channels, national radio broadcast networks, satellite channels, and the like, include multiple broadcast markets. Examples of national television broadcast networks include ABC, NBC and CBS; examples of nation cable network channels include ESPN, CNN, The Comedy Channel, HBO, etc. To compensate for time differences between distant markets, multi-market broadcasters may transmit (or may direct others to transmit on their behalf) multiple feeds of their broadcast. These feeds may be simply time-delayed or may also include changes in the programming. Some events, like speeches and certain championship sporting events may be covered live across all time zones.

The responsibility for the selection and arrangement of featured programs (i.e., the programming) varies by the type of broadcaster. In the case of television broadcasts, local television stations typically have an affiliation to (and may be owned by) a national television broadcast network (e.g., ABC, NBC, or CBS). The national television broadcast network typically determines and provides all of the programming during predefined “prime time” hours, which are generally the weekday evening hours during which the viewing audience reaches a maximum. The programming during these time periods may be delivered to each affiliated local television station from the national television broadcast network in one or more so called “network feeds.” Local radios stations may have a similar affiliation with a national radio broadcast network that determines certain programming of the local radio station broadcast.

The programming of local broadcasters and of multi-market broadcasters (e.g., a national cable network channel) may also be provided in part by a syndicator, which owns rights to distribute certain programs that are in “syndication.” In the case of a local television broadcaster affiliated with a multi-market broadcast network, programming provided by a syndicator is broadcast in non-prime time hours. Typically syndicators provide programming in all or a large number of the markets in a nation or region.

For the purposes of this description, the organization that determines the programming of a broadcast is described as the broadcast originator or distributor of that programming. Thus, a national broadcast television network is the broadcast originator or distributor of programming which is (usually) aired during prime time hours and other shows which have national interest. Such programming will appear only on the affiliates of that network. Similarly, a syndicator is the broadcast originator or distributor of its syndicated programming broadcast by a local or multi-market broadcaster; however syndicated programs are not restricted to any one network. And, the local broadcaster is the broadcast originator or distributor for programming determined by the local broadcaster itself. For example, a local television station is typically the broadcast originator (or distributor) of non-prime time programming not in syndication, such as a local news program.

Advertisers of commercial goods and services may purchase space for advertising from any of the three types of broadcast originators (or distributors) during the time for which the distributor is the broadcast originator for the programming of a broadcast. An advertising “buy” from a particular distributor may include detailed specifications as to the space(s) desired for the advertisement, such as the featured programs, dates, days of the week, time range, duration, markets and number of instances. The purchase may be for commercial air time on a market or outlet basis (spot or local cable), or it could be at the national network level where its part of the national feed which is sent out across the country. Advertisers also include detailed specifications as to the particular content or advertisements to be placed in the desired spaces (i.e., “traffic” information). The combination of the buy and traffic specifications is referred to herein as “flight information.”

To enhance the effect of broadcast advertising campaigns, an advertiser will often purchase advertising space from a number of different distributors with varied buy and traffic information. Further, typically such purchases may be arranged and managed by an advertising agency or media buyer that may have a large number of such clients. Therefore, it can be appreciated that the tasks of managing and confirming fulfillment of advertising orders can be complex and burdensome.

In an effort to confirm that orders for advertising have been properly fulfilled, entities responsible for broadcasting advertisements (i.e., the broadcast originators or distributors) typically produce sworn affidavits in which the affiant declares that the orders have been satisfied. However, these affidavits are not prepared by disinterested persons and, in addition, are subject to human error. Other efforts to confirm that orders for advertising have been properly fulfilled include the employment of independent human viewers to manually catalog broadcasts of advertisements. This method is also subject to human error, and this method is not feasible for the currently large and continually growing number of broadcasts. Further methods include electronic monitoring of broadcasts. However, none of the confirmation methods known heretofore provide significant advantages or improvements in matching multi-market broadcasts of advertisements to multi-market advertising orders or in providing dynamic reports regarding fulfilled and unfulfilled orders.

Therefore, what is desired is broadcast advertisement tracking, managing and reporting method and system that provide accurate, independent confirmations of the fulfillment of broadcast advertising orders, that provide significant advantages in matching multi-market broadcasts of advertisements to multi-market advertising orders, that provide significant advantages in reporting of fulfilled and unfulfilled orders and that provide such matching, confirmation and reporting for a large number of broadcasts over a large number of broadcast markets.

The present invention overcomes the limitations of prior methods of confirming fulfillment of order for broadcast items, such as commercial advertising orders, and provides substantial improvements in the efficiency and accuracy of such confirmation and in the ability to produce dynamic reports or fulfilled and unfilled orders. A system established according to the present invention includes a plurality of electronic detection devices located in the various broadcast markets that are configured to receive and analyze broadcasts on a number of channels of a number of broadcast mediums.

The detection devices detect instances of actual broadcasts of encoded broadcast items, such as encoded advertisements, and record information regarding each detected actual broadcast in a log. Any suitable method for encoding or assigning unique codes to broadcast items may be employed with the present invention; however, preferably the method is able to detect the date, time, channel and duration of the broadcast item, in addition to the code.

In the method of the present invention, detection information is consolidated from the plurality of detection devices and processed. In the processing of detections, related multi-market detections of instances of actual broadcasts of encoded broadcast items are associated to one another, by one or more computing devices, using various reference data and published program schedules. The associated multi-market detections are then associated with a related multi-market order received from an advertiser or agency to indicate whether, and to what extent, the multi-market order has been fulfilled. Further, single-market detections of instances of actual broadcasts of encoded broadcast items are associated with related market focused advertising orders (i.e., “spot” buys) to indicate whether (and to what extent) the single-market advertising order has been fulfilled. In addition to recognizing accurately fulfilled advertising orders, the method also recognizes a number of predetermined commonly occurring errors in fulfilling orders, such as the broadcast of an incorrect advertisement in the correct space. The method also provides detailed reports of fulfilled, erroneous and unfulfilled advertising orders, with the ability to quickly and conveniently access or, “drill down” to, detailed information regarding the individual detections associated with multi- and single-market advertising orders.

### BRIEF DESCRIPTION OF THE DRAWINGS

For a complete understanding of the above and other features of the invention, reference shall be made to the following detailed description of the preferred embodiments of the invention and to the accompanying drawings, wherein:

FIG. 1 is a schematic diagram of the method of the present invention;

FIG. 2 is a schematic diagram of the system of the present invention; and

FIGS. 3-11 are examples reports and queries generated by the present method and system.

### DETAILED DESCRIPTION OF THE PREFERRED EMBODIMENTS

Step 1—Reference Information

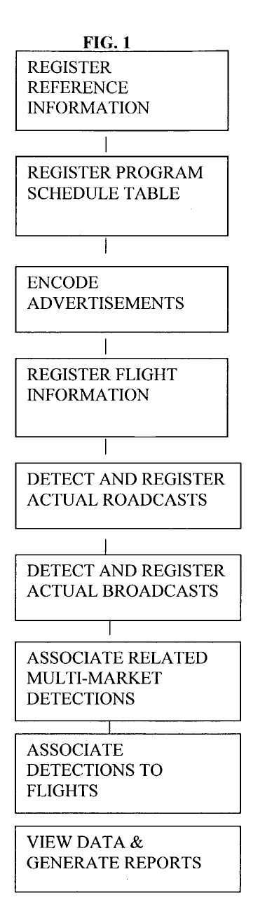

Referring to FIG. 1, a first step in the method of the present invention comprises the gathering and registration of certain reference information to be used in associating related detections of actual broadcasts of encoded broadcast items (e.g., encoded advertisements) with one another, and in associating such detections to related advertising orders. Such reference information includes advertising agency (media buyer) information, broadcaster information, syndication information, monitoring device information, and authorized user information.

Agency Information

Agency information includes information on the advertisements for which each agency is responsible, the definition of the “broadcast day” for the agency, and the time allowances for each agency, which may vary depending on the client, and the type of advertising (e.g., multi-market or single-market focused).

By industry custom, individual advertisements are assigned a unique code that may be used to distinguish the advertisement from others and may be used to determine the advertising agency and client responsible for the advertisement. In television, the code is the ISCI code, which is distributed by an industry organization, AAAA. In the present method, information regarding the agency, the advertisements associated with the agency and the date range that the agency is associated with the advertisement are held in an agency commercial table having the following fields:

AGENCY COMMERCIAL TABLE

ISCI CODE
AGENCY NAME (or Code)
CLIENT NAME (or code)
START DATE (hired)
END DATE (fired)

Preferably, in the present system, clients with both multi-market and single-market advertising campaigns are given two distinct CLIENT codes to distinguish campaigns in the system and to allow variations in other configurations of the system.

For each agency, the “broadcast day” may not match with the calendar day. Often the broadcast day begins and ends at 1 or 2 a.m. and sometimes as late as 6 a.m. The definition may vary depending on the client and the type of advertisement that is being placed for the client (i.e., either a multi-market or national advertisement order, or a single-market focused advertisement order). This information may be stored in a broadcast day computer database table having the following fields:

BROADCAST DAY TABLE

AGENCY NAME (or code)
CLIENT NAME (or code)
CUT-OFF TIME

The agency information also includes information regarding the time allowances customarily given to distributors for placing advertisements, which may vary depending on the agency and client, and whether the advertisement is for a local or multi-market (e.g., national) advertising campaign or a single-market campaign. The time allowance is commonly +/−2 minutes for a single-market advertising order and 0 minutes for a multi-market (or “national”) order. This information may be stored in a time allowance database table having the fields identified below.

TIME ALLOWANCE TABLE

AGENCY NAME (or code)
CLIENT NAME (or code)
FROM TIME ALLOWANCE
END TIME ALLOWANCE

In flight information, different agencies may use various abbreviations or codes for different channels or distributors. For example, one agency may use “DSC” for the “The Discovery Channel”, while another may use “DISC” or “TDC”, etc. Therefore, the system preferably includes a call letter translation table to convert call letter provided by agencies in flight information to a standard code for the system. The call letter translation table may contain the following fields:

CALL LETTER TRANSLATION TABLE

AGENCY
AGENCY VERSION OF CALL LETTER
SYSTEM VERTION OF CALL LETTER

Broadcaster Information

Information for Broadcast Networks, Local Broadcaster stations, National Cable Networks, and syndication settings are stored in a station table containing station/broadcaster information.

STATION TABLE

CALL LETTER
BROADCAST MARKET
(e.g., “NY” or “LA”, etc. for single-market or “NATL” for
multi-market, or national)
NATIONAL CALL LETTER (affiliated network if broadcast station)
STATIONTYPE

For example

Broadcast station WABC in New York would be defined as

WABC, NY, ABC, TV

National Cable channel SCIFI would be defined as

SCIFI, NATL, SCIFI, CTV

National Syndicator Columbia Tristar would be defined as

CTS, NATL, CTS, STV

National Network ABC would be defined as

ABC, NATL, ABC, TV

The system also contains additional information regarding National Broadcast networks prime time coverage. The prime time period for each multi-market broadcaster varies depending on the market, the day of the week, and whether the locality of the market adheres to a seasonal time shift, such as daylight savings time. This information can be stored in a prime time table having the following fields:

PRIME TIME TABLE

NATIONAL CALL LETTER
MARKET
DAY OF WEEK
FROM TIME
TO TIME
SEASONAL TIME SHIFT

Syndication Information

The information regarding syndications includes syndicator names, which may be partial or complete names and an associated code for the syndicator, which may be an abbreviated code. This information may be stored in a syndicator table having the following fields:

SYNDICATOR TABLE

SYNDICATOR NAME
SYNDICATOR CODE

Syndication information also includes programs known to be in syndication and the associated syndicator. This information may be stored in a syndication programs table having the following fields:

SYNDICATIONS PROGRAMS TABLE

SYNDICATION PROGRAM NAME
SYNDICATOR CODE

Syndication information further includes a list of programs in syndication that appear on different days of the week in different markets. This information may be stored in a weekly syndication table having the following fields:

WEEKLY SYNDICATION TABLE

SYNDICATION PROGRAM NAME

Split Channels

Cable distributors sometimes elect to vary the source of the broadcast that is distributed on a given frequency (channel). For example, a cable distributor may choose to air children's programming in the morning, and then change the feed to pick up a news program in the afternoon and evening. As another example, a cable network may sublet part of its broadcasting day to another channel. A specific example of this is the USA Cable network which sublets part of its early morning time to Bloomberg.

To properly attribute the source of the broadcast, the system preferably includes a split channel table having the following fields:

SPLIT CHANNEL TABLE

REPORTED CALL LETTER
MONDAY
TUESDAY
WEDNESDAY
THURSDAY
FRIDAY
SATURDAY
SUNDAY
FROM TIME
TO TIME
SOURCE CALL LETTER
BROADCAST MARKET

Monitoring Device Information

The information regarding the electronic monitoring devices of the system includes a unique identifier for each device and the broadcast market in which the device is physically located. This information may be stored in a monitoring device table, having the following fields:

MONITORING DEVICE TABLE

DEVICE I.D.
LOCATION MARKET

Time Adjustment for the Cable Networks

Another reference table of the system contains information that defines the default time adjustment value for each market that is to be applied to detections on cable networks to associate related actual detection records to each other. This table holds the appropriate time adjustments for cable network programs in specific markets with respect to a base time zone (e.g., ET). The information may be stored in a national cable adjustment table having the following fields:

NATIONAL CABLE ADJUSTMENT TABLE

NATIONAL CALL LETTER
BROADCAST MARKET
TIME ADJUSTMENT
SEASONAL TIME SHIFT
FEED (e.g., “East” or “West”)

Cable networks may have one feed or may have multiple, time-delayed feeds. To account for the difference in the local time of programs in various markets, the TIME ADJUSTMENT fields of the records in the national cable adjustment table for each market are predetermined and include a time adjustment value appropriate to adjust a local time of a program or detection in that market to the corresponding time in a base time zone (e.g., ET).

In the case where a cable network has one feed, the programs are aired simultaneously in each market. In this instance, the local time of each program will vary depending on the time zone of the market. Thus, the record in the national cable adjustment table for the LA market for a one-feed cable network may have a TIME ADJUSTMENT field equal to +180 (minutes).

Other cable networks have multiple feeds, which are usually identical East and West coast feeds that are simply time delayed 3 hours to adjust for the time difference between the Eastern and Pacific time zones. Thus, a program on at a local time of 9 p.m. on the East coast is also on at a local time of 9 p.m. for the West coast. However, the program will appear at a different local time in markets in time zones between the Eastern and Pacific time zones, such as markets in the Central and Mountain time zones.

Thus, the values of the TIME ADJUSTMENT fields in the records of national cable adjustment table for such multi-feed cable networks for certain markets (e.g., market in the Eastern and Pacific time zones) will be zero (0). However, the values of such TIME ADJUSTMENT fields for markets between the Eastern and Pacific time zones will depend on which feed the particular market receives (i.e., either the East or West coast feed). Such values are preferably predetermined and placed in the appropriate records of the national cable adjustment table. As above, these TIME ADJUSTMENT values of the national cable adjustment table are employed to populate the TIME ADJUSTMENT fields of records in the program schedule table during processing of the cable network schedules.

Step 2—Program Schedule Table

Published Schedule Information

Another step in the method comprises gathering and registering published schedule information from various markets to build a multi-market schedule table. Certain schedules, such as television broadcast and cable schedules and are published in advance and are publicly available. Further, such schedules are often available in electronic format, or in a format that may be converted to an electronic format. Typically, separate schedules are published for each television market and include a date, a name (or description) of each featured program (e.g., show, sporting event or news event, etc.), a channel number, call letters for the broadcaster, and a start and end time. This information is gathered from the published schedules preferably by a computer algorithm adapted to locate and extract the desired information. The scheduled program data is preferably gathered on a regular basis, for example daily or weekly. A history of schedule information is preferably maintained in the program schedule table until such time as it is no longer needed.

Once gathered, the information is placed into the following fields of the program schedule table:

PROGRAM SCHEDULE TABLE

DATE
PROGRAM NAME
BROADCAST MARKET
BROADCASTER CALL LETTER
TYPE OF STATION
START TIME
END TIME

Distributor Determination

Then, for each program listing in the program schedule table, a look-up is performed in the station table, based on the CALL LETTER field of the program schedule table to determine the network affiliation of the broadcaster of each program listing, if any. The code for the network affiliation of the broadcaster, if any, is then placed in a supplemental NATIONAL CALL LETTER field and in a supplemental DISTRIBUTOR field of the appropriate record in the program schedule table. This indicates, at least presumptively, that the affiliated national broadcast network is responsible for the program. If there is no network affiliation for the broadcaster, then the value in the CALL LETTER is copied to both the NATIONAL CALL LETTER field and DISTRIBUTOR field to indicate, at least presumptively, that the local broadcaster is responsible for the program.

Then, each program listing in the broadcast schedule table is compared to the prime time table information to determine if the program listing occurs outside “prime time” for that market/network/day-of-week combination. If the program listing occurs outside the FROM TIME and TO TIME of the MARKET+NATIONAL CALL LETTER+DAY OF WEEK combination then, the PROGRAM NAME in the program schedule table is compared to the SYNDICATION PROGRAM NAME field in the syndication program table to determine if the program is a known program in syndication. If a match is found, then the associated SYNDICATOR CODE of the syndication program table is copied to the DISTRIBUTOR code of the program schedule table to indicate that the syndicator is responsible for the program.

Intra-Day Time Adjustments

For each schedule date, the START TIME for each program listing in the program schedule table is then compared to the START TIME of a first occurrence of a like DATE+PROGRAM NAME+DISTRIBUTOR combination in the program schedule table in a predetermined base market (e.g., the NY market). A supplemental TIME ADJUSTMENT field in the record for the first occurrence is set to zero (0) and the supplemental TIME ADJUSTMENT field in the compared record is set to the time difference (in minutes) between the START TIME of the first occurrence of the combination and the START TIME of the compared record. Preferably, the TIME ADJUSTMENT field has a negative value if the value in the START TIME field of the first occurrence of the combination is greater than that of the compared record.

Non-Standard Overrides

If desired, the TIME ADJUSTMENT field for certain program listings may be corrected using predefined program instruction specifically tailored to set the correct time adjustment value for specific DATE+DAY OF WEEK+MARKET+START TIME combinations.

Weekly Syndication

Some programs in syndication occur on different days of the week in different markets. Therefore, after the intra-day time adjustment process is completed, the PROGRAM NAME field of the program listings in the program schedule table within a 7-day (inter-day) window, in the base market (e.g., the NY market), is compared to the SYNDICATION PROGRAM NAME field of the syndications programs table. If a match is found, then the program listings for all markets within the same inter-day window are compared to the first occurrence of the PROGRAM NAME+DISTRIBUTOR combination in the base market. If a match is found, the TIME ADJUSTMENT field of the compared record is adjusted according to the difference in time (in minutes) between the DATE+START TIME of the first occurrence of the program and the DATE+START TIME of the compared record. For example if a syndicated weekly program is scheduled to first occur in the NY market on Friday at 10:30 a.m. to occur in the LA market on Thursday at 9:30 a.m., then the TIME ADJUSTMENT field for the program listing in the LA market would be −1500 minutes (25 hours×60 minutes/hour).

Cable Networks

A separate schedule process is used to analyze and register the program schedules for cable networks. As stated above, cable networks may have a single feed or may have multiple, time-delayed feeds. For single-feed cable networks, preferably only one record is created in the program schedule table for each program, and the START TIME and END TIME for the record are preferably the times in the base time zone (e.g., ET). For multiple-feed cable networks, preferably one record is created for each feed for each program (e.g., 2 records for each program for a cable network having and East cost and West coast feeds), and the START TIME and END TIME of the records are set according to Eastern and Pacific time zones.

Cable networks having multiple feeds will have a schedule for each feed. A primary schedule will be for a time zone of the base market (e.g., NY) and secondary schedule(s) will be for other time zones. The secondary schedule(s) for (typically there is only one secondary schedule) are compared to the schedule of the base market in a manner similar to that described above for broadcast stations an the time difference between programs is placed in the TIME ADJUSTMENT field of the record in the program schedule table related to that program for that feed.

Step 3—Encode Advertisements

Advertisements or other broadcast items to be tracked by the method are assigned a unique detection code, which is preferably the same as the associated ISCI code. Preferably, the detection code is embedded within the audio and/or video signal of the advertisement in a manner that permits the electronic extraction of the detection code during subsequent playback of the advertisement using specially adapted detection equipment. However, any other suitable method will suffice. For example a method of assigning and detecting a unique detection code that does not require the alteration of the original advertisement is within the scope of the method of the present invention. Such a unique code could be based on the inherent audio and/or video content of the advertisement, and thus is considered herein to be (inherently) “embedded”, notwithstanding the fact that the original advertisement is not altered.

Information regarding the encoded advertisements may be held in an encoded advertisements table having the following fields:

ENCODED ADVERTISEMENTS TABLE

ISCI CODE
CLIENT NAME
AGENCY NAME
DURATION
MULTI-MARKET BROADCAST
DETECTION CODE
COMMERCIAL TITLE

When commercials are registered in the system the MULTI-MARKET BROADCAST field is set to indicate whether the commercial is intended for a multi-market (e.g., national) advertising order or for a single-market advertising order, where, for example a value of “Y indicates a national order.

Step 4—Flight Information

Flight information may be provided by (or on behalf of) an agency in two parts—one part containing the “buy” information and a second part containing the traffic information, or may be provided as one unit. Buy information may be delivered or available in electronic form, such as an ASCII text computer file having separate line items for the buy information. The format of such files may vary somewhat depending on the agency or source, however the format is usually similar amongst different sources and is typically consistent within any given source. Traffic information may be delivered electronically, verbally or in paper form.

Buy information typically includes the following information:

CLIENT
PRODUCT DESCRIPTION
ESTIMATE NUMBER
CALL LETTER (if single-market, or “spot”)
NATIONAL CALL LETTER
(if multi-market, or “national”)
START DATE
END DATE
DAY ROTATION (e.g., M-F, SAT)
LENGTH OF SPOT
START TIME
END TIME
PROGRAM NAME
UNITS

The buy information is preferably first loaded into one of a plurality of holding tables that is specific to the source of the buy information. This step is preferably accomplished using a parsing program, specific to the source of the buy information, that extracts the data from the buy information and loads the data into appropriate fields of the holding table.

Then a conversion program converts the buy information into the format described below and loads the information into a flight information table. In the conversion, a separate record is created for every unit specified in each line item of the buy information. For example, if a line item of the buy information specifies 3 UNITS, then the line item of the buy information will be converted to three records in the flight information table, each record having an ITEM NUMBER of “1 of 3”, “2 of 3” or “3 of 3”, respectively. The total number of spots in the line item of the buy information is recorded in a TOTAL SPOTS field in each of the records related to the line item of the buy information. Further, the START DATE, END DATE and DAY ROTATION information indicated in the line item of the buy information is converted (if necessary) to a WEEK OF field and daily fields: MONDAY, TUESDAY, WEDNESDAY, THURSDAY, FRIDAY, SATURDAY and SUNDAY. For example, if the DAY ROTATION value in the buy information was M-W, the values for the daily fields would be Y,Y,Y,N,N,N and N, respectively.

Further, during conversion, a look-up is performed in the time allowance table, based on the AGENCY+CLIENT+MULTI-MARKET BROADCAST fields in each flight record to obtain the associated time allowance from the time allowance table. A FROM ALLOWANCE field of the flight record is set to equal the FROM TIME field less the FROM TIME ALLOWANCE, and a TO ALLOWNCE field of the flight record is set to equal the TO TIME field plus the TO TIME ALLOWANCE.

If the traffic information is included with the buy information, the associated ISCI codes are placed in an ISCI GROUP field for each record of the flight information table. If the traffic information is delivered separately from the buy information, then the associated ISCI codes for the line item of the buy information are added manually either prior, during or after conversion of the buy information to the flight information table.

Further, if the buy information relates to a multi-market (e.g., national) advertisement order, the CALL LETTER field of the record in the flight table for each line in the buy contains the National Network, Cable or Syndication call letter. (e.g., “ABC” for the ABC network), and the BROADCAST MARKET field value is set to “NATL”. If the buy is for a single-market or local distributor level than the CALL LETTER field will contain the call letter for the local broadcaster or cable channel and the BROADCAST MARKET field value is set to the value of that individual market (e.g., “NY” or “LA”, etc.). The call letter translation table may be employed during this process to translate call letters provided by the agency.

After the conversion is performed and the initial reference information is added, the following fields of the flight information table are generally populated.

FLIGHT INFORMATION TABLE

CLIENT
ESTIMATE NUMBER
AGENCY
CALL LETTER
BROADCAST MARKET
PROGRAM NAME
TOTAL SPOTS PURCHASED
ITEM NUMBER
FROM TIME
TO TIME
FROM ALLOWANCE
TO ALLOWANCE
WEEK OF
MONDAY
TUESDAY
WEDNESDAY
THURSDAY
FRIDAY
SATURDAY
SUNDAY
ISCI GROUP
DURATION
FLIGHT ROW NUMBER
DETECTION I.D. (typically not populated at this point)
(or, DETECTION ROW NUMBER)

As described below, each record of the flight information table includes other fields for associating flight information to detections of broadcast advertisements. For example, the records of the flight information table include a DETECTION I.D. field which is used to associate flight records to detection records, as described further below.

If an agency revises an advertising buy order, the system compares the buy information already in the system with the new information and applies corrections to the tables as needed. This process may simply overwrite the records in the flight information table related to the same flight “estimate” within the date range specified in the revised buy information. Depending on the contents of the change, the change may also require the traffic information (i.e., the ISCI GROUP) to be reviewed and possibly reapplied to the new flight records.

Step 5—Detections

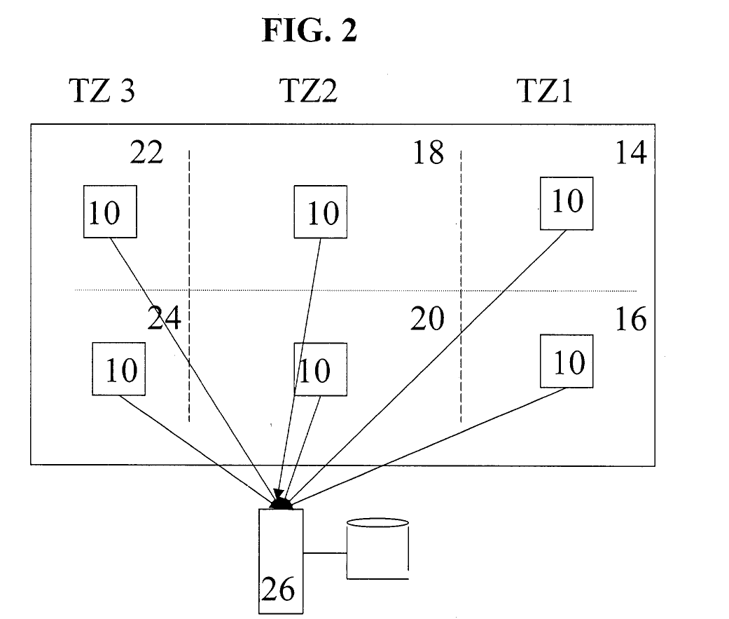

Referring to FIG. 2, the method and system of the present invention comprises a plurality of electronic detection devices 10 located in various broadcast markets 14, 16, 18, 20, 22, 24 in a plurality of time zones (TZ1, TZ2, TZ3) that are configured to receive and analyze broadcasts on a number of channels of a number of broadcast mediums. Two or more detection devices may receive signals from the same channel in the same market to provide redundancy and fault tolerance, in which case duplicative detection records from redundant detection devices are preferably identified and/or removed. The detection records are transmitted to a central processing site 26 for analysis and reporting.

The detection devices detect actual market broadcast instances of encoded broadcast items, such as encoded advertisements, and record information regarding each detected actual market broadcast instance, including a unique code for the device, a unique code for the detection event, and the date, time, channel, duration, and detected code. The detection information is consolidated from the plurality of detection devices and processed, and, as described further below, compared to expected broadcast occurrences specified by the flight information.

Detection information from each detection device is initially enhanced with certain reference information which is placed in the associated records of the detection table. The sources of the reference information used to initially enhance the detection information may include the monitoring device information, the channel information and the local broadcaster information. After initial enhancement, the following fields of the detection table are generally populated:

INITIALLY ENHANCED DETECTION TABLE

DEVICE I.D.
DETECTION I.D.
DETECTED CODE
DURATION
LOCAL DATE
LOCAL TIME
CALL LETTER (may differ if split channel condition)
REPORTED CALL LETTER
DEVICE MARKET
BROADCAST MARKET

The values in the CALL LETTER field may be obtained from the split channel table based on the REPORTED CALL LETTER provided by the detection device at the time of detection.

Then, the detection information is enhanced further with the program schedule information. In particular, PROGRAM NAME, NATIONAL CALL LETTER, DISTRIBUTOR and TIME ADJUSTMENT field information associated with the program scheduled to air during each detection is placed in the PROGRAM NAME, NATIONAL CALL LETTER, DISTRIBUTOR and TIME ADJUSTMENT fields in the detection records in the detection table. Specifically, a look-up is performed based on the LOCAL DATE+LOCAL TIME+BROADCAST MARKET+CALL LETTER+TYPE OF STATION combination of the detection record for a match in the respective fields of the program schedule table, and the information from the PROGRAM NAME, NATIONAL CALL LETTER, DISTRIBUTOR and TIME ADJUSTMENT fields of matching record in the program schedule table is placed in the respective fields of the matching record in the detection table. It can be appreciated that, for a match, the LOCAL TIME of the detection record will be within the START TIME and END TIME of the matching record in the program schedule table.

Broadcast station schedules are relatively complex and are therefore preferably stored individually. Therefore, for queries regarding broadcast station programs, the specifics of the detection is used directly. Since national cable channels are not as complex, it is unnecessary to store each markets copy of that cable network.

For detections from cable networks the national cable adjustment table is referenced to obtain the FEED and the TIME ADJUSTMENT value for the BROADCAST MARKET of the detection record. Then, a look up is performed on the program schedule table to determine if a further time adjustment is necessary. A further time adjustment will be necessary if, for example, a cable network has multiple feeds that are time-delayed and the multiple feeds have different schedules, such as a live event. The TIME ADJUSTMENT value from the program schedule table is combined with the TIME ADJUSTMENT value from the national cable adjustment table and the combination is placed in the TIME ADJUSTMENT field of the detection record.

The detection information is also enhanced with the encoded advertisements information and the agency commercial information. Specifically, the DETECTED CODE of each detection record is used to perform a look-up in the encoded advertisements table to obtain the associated ISCI CODE, which may be placed in an ISIC CODE field in the associated detection record. Alternatively, the ISCI CODE of the encoded advertisements table may simply overwrite the DETECTED CODE in the associated detection record. In addition, the AGENCY, CLIENT and MULTI-MARKET BROADCAST associated with the ISCI CODE is obtained from the encoded advertisement table with a look-up based on the ISCI CODE. Alternatively, AGENGY and CLIENT associated with the ISCI CODE may be obtained from the agency commercial table with a look-up based on the DETECTED CODE or ISCI CODE.

The detection information is also compared to the broadcast day information to determine if the actual detection date should be adjusted to correspond with the associated broadcast day. Specifically, the LOCAL TIME of each detection record is compared to the CUT-OFF TIME of the record in the broadcast day table having the same AGENCY+CLIENT combination as the detection record. If the LOCAL TIME of the detection record is less than the CUT-OFF TIME of the matching broadcast day record, then one day is subtracted from the LOCAL DATE field of the detection record.

The detection is further enriched with a day part label by looking up what DAY PART this detection corresponds to, which information may be held in a reference table.

Preferably, the record is also enhanced with the corresponding date and time of the base time zone (e.g., ET) in BASE TIME-ZONE DATE and BASE TIME-ZONE TIME fields of the record, which may be calculated using the geographic location of the monitoring device (e.g., the DEVICE MARKET), the LOCAL DATE and the LOCAL TIME, provided the time difference between the location and the time zone of the base market is known.

The detection information may then be placed in a processed detections table having the fields described above.

Step 6—Associate Related National Detection Records

Review of Base Market

To associate related market detection records to one another, records of the processed detections table are compared to one another to determine if they are related to the same broadcast. Related market detection records are associated with an anchor detection record in the processed detections table, which may be a discrete “synthetic” record or which may be a designated one of the actual detection records. Specifically, each detection record related to a multi-market advertisement, which detection is from a predefined base broadcast market (e.g., NY), is reviewed to see if a matching anchor detection record already exists for the compared detection record.

As set forth above, a multi-market detection record is one that has an ISCI CODE which matches a record in the encoded advertisements table that has a MULTI-MARKET BROADCAST value indicating that the advertisement associated with the ISICI CODE is intended for a multi-market advertising campaign or order (e.g., with a value of “Y” or “NATL”).

A multi-market detection record will match an anchor detection record if the two records have the same ISCI CODE, DISTRIBUTOR and adjusted detection date and time, where the adjusted detection date and time is determined using the LOCAL DATE and LOCAL TIME of the compared detection record as adjusted by its TIME ADJUSTMENT. For example, a detection record having an ISCI CODE of “AAA1234”, a DISTRIBUTOR of “ABC”, a LOCAL DATE of “11/20/2002”, a LOCAL TIME of “10:00:00” and a TIME ADJUSTEMENT OF “−60” will match an anchor detection record having a LOCAL TIME of “09:00:00”, and the same ISCI CODE, DISTRIBUTOR and LOCAL DATE.

Additionally, a match between an actual detection record and an anchor detection record is preferably made if the adjusted date and time of the actual detection record is within a predetermined first association time window (e.g., about 5-60 minutes) of the LOCAL DATE and LOCAL TIME of the anchor record. That is, a predetermined variance is allowed such that an exact date/time match is not required. However, preferably, if more than one record is within the time window, the record most closely matching record is chosen.

If a match with an anchor detection record is found, then all of the actual detection records associated with that anchor detection record, if any, are reviewed to see if another actual detection record having the same BROADCAST MARKET as the compared detection record has already been associated with the anchor detection record. If no such other detection record has been associated with the anchor detection record, then the compared detection record is associated with the anchor detection record. Such an association can be created by placing the table row number of the anchor detection record in an ANCHOR DETECTION ROW field in the compared record, or by any other suitable method of creating an association.

When a detection record is associated with an anchor detection record, a MARKET COUNT field of the anchor detection record is preferably incremented by 1. As can be appreciated, the MARKET COUNT field holds a value equal to the number of individual detection records associated with the anchor detection record.

If a matching anchor detection record is not found for the compared actual detection record, then a new anchor detection record is created (with a MARKET COUNT of 1) and the compared detection record is associated with the new anchor record, as described above.

Preferably, the anchor detection record is a discrete, or “synthetic” record and is distinguished from actual detection records in the processed detections table. For example, a distinguishing value is placed in a predetermined field in the record, such as the BROADCAST MARKET field. The distinguishing value can be “Anchor”, “National” or “NATL”, or some other predetermined distinguishing value. Further, several fields from the actual detection record are copied to the anchor detection record, including:

ANCHOR DETECTION RECORD FIELDS FROM
ACTUAL DETECTION RECORD

DETECTION I.D. (detection record row number)
LOCAL DATE
LOCAL TIME
PROGRAM NAME
NATIONAL CALL LETTER
DISTRIBUTOR
ISCI CODE
AGENCY
CLIENT

Removal of Non-Qualified Anchor Records

Then, the MARKET COUNT value of each anchor detection record is compared to a predetermined minimum value. If the MARKET COUNT value of an anchor detection record is less than a predetermined minimum value and the anchor detection record is not associated with a record in the flight information table (as discussed below), the anchor detection record is considered to be non-qualified and the associations between the associated actual detection records and the anchor record are eliminated (e.g., by clearing the ANCHOR DETECTION ROW field of the actual detection records). Further, if the non-qualified anchor detection record is a discrete record, the anchor detection record is deleted from the processed detections table.

Review of All Markets

Next, the unassociated actual multi-market detection records from each market are compared to the existing anchor detection records to determine if the actual detection records are related to an existing anchor detection record. As above, a match is found when the actual detection record and the anchor market detection record share the same ISCI CODE, DISTRIBUTOR and adjusted date and time, as described above. However, preferably a secondary association time window greater than the initial association time window (i.e., a larger variance) is allowed. If a match is found, the ANCHOR DETECTION ROW and MARKET COUNT fields are updated accordingly.

Further, the remaining unassociated actual multi-market detection records from each market are compared to the existing anchor detection records. In this instance, a match is found if the NATIONAL CALL LETTER, BASE TIME-ZONE DATE and BASE TIME-ZONE TIME match the NATIONAL CALL LETTER, LOCAL TIME and LOCAL DATE of the anchor detection record, again with a time window greater than the initial associated time window. As above, if a match is found, the ANCHOR DETECTION ROW and MARKET COUNT fields are updated accordingly.

Finally, the remaining unassociated actual multi-market detection records from each market are compared to the existing anchor detection records, where, in this instance a match is found when the actual detection record and the anchor detection record share the same ISCI CODE, DISTRIBUTOR, and adjusted detection date and time with a time window greater than the secondary association time window. If no match is found for a remaining unassociated multi-market detection record in this instance, an anchor detection record is created for the record and the MARKET COUNT (value of 1) and ANCHOR DETECTION ROW fields are set accordingly.

The result of the process of associating related market detections is a processed detection table having four types of records: (1) qualified anchor detection records associated to at least the predetermined minimum number of actual detection records (BROADCAST MARKET=“NATL”), (2) anchor detection records associated less then the Minimum number of markets (BROADCAST MARKET=“NATL”), (3) actual detection records associated with anchor detection records, and (4) actual detection records not associated with anchor detection records. The records of Type (2) may be considered a “local anomalies” of detections of multi-market advertisements. The records of Type (4) are detections of single-market or “spot” advertisements.

Step 6—Associating Detections to Flights

Associating Detections to Flights

As described above, the flight information may be either national in nature (i.e., multi-market) or focused on specific (single) markets. As a result the CALL LETTER and BROADCAST MARKET fields have been set accordingly and indicate whether the record is related to a multi-market or single-market advertising order. For example, a record for a national flight could have the CALL LETTER “ABC” and “NATL” as the BROADCAST MARKET. On the other hand, if the flight is focused on the New York market, the CALL LETTER could be “WABC” and the BROADCAST MARKE could be “NY.”

On the detection record side, the anchor detection records (e.g., with a BROADCAST MARKET of “NATL” (either Type 1 or 2 from above) have been generated from the individual actual detection records for multi-market (e.g., national) advertisements. The anchor detection records are either qualified or non-qualified (i.e., “local anomalies”). In either case, the individual actual detection records for the multi-market advertisements (Type 3 from above) have been associated to a anchor detection record and to themselves via a common value in the ANCHOR DETECTION ROW field. The type 4 actual detection records are single-market (i.e., non-national) market records.

Direct Match

Previously unassociated (or unmatched) qualified anchor detection records (Type 1) and single-market actual detection records (Type 4) are compared with unassociated (unmatched) multi-market flight information table records and single-market flight information table records, respectively. As described above, the flight information table records relate to line item details in the buy information.

The system checks each unassociated flight record to see if a corresponding unassociated detection record exists which completely satisfies the criteria of the flight record. A detection record will completely satisfy the criteria of the flight record when: (1) the AGENCY, CLIENT, BROADCAST MARKET, CALL LETTER and DURATION/LENGTH OF SPOT fields of the detection and flight records are the same (2) the ISCI CODE of the detection record is within the ISCI GROUP of the flight record, (3) the LOCAL DATE of the detection is within the week defined by the WEEK OF field of the flight record, (4) the day of the week of the detection record matches an allowable day of the week of the flight record (i.e., one of the MONDAY, TUESDAY, WEDNESDAY, THURSDAY, FRIDAY, SATURDAY or SUNDAY fields), and (5) the LOCAL TIME of the detection record is within the START TIME and END TIME of the flight record. Further, if the records being compared are related to a syndicated program, the PROGRAM NAME fields of the detection record and the flight record must match.

When a match is found, the flight and detections records are updated to associate each with the other. Specifically, the DETECTION I.D. field of the flight record is updated to contain the DETECTION I.D. of the corresponding detection record, and the FLIGHT ROW field of the detection record is updated to contain the row of the corresponding flight record. Furthermore, if the detection record is an anchor detection record, then the FLIGHT ROW fields of all of the actual detection records associated with the anchor detection record (i.e., all which share the same ANCHOR DETECTION ROW value) are updated to contain the row of the corresponding flight record. As described below, this mutual updating allows for detailed reporting and, in effect, takes the associated records out of the pool of unassociated records.

In addition, a FLIGHT MATCHED field of the flight record may be set (e.g., to “1”, “YES”) to indicate that the flight is associated with a detection record.

Further, in the case of a direct match, a FLIGHT PURCHASED field of the flight record may be set (e.g., to 1) to indicate that the detected occurrence of the broadcast advertisement was one of the units indicated in the line item of the buy information.

Preferably, flight records are compared in a predetermined order to optimize matching accuracy. For example, prior to or during matching, the flight records may be sorted. Primarily, the flight records may be sorted by a time window specified in the fight record, which may be held in a TIME WINDOW field in the flight record. The time window is the difference between the FROM TIME and the TO TIME of the flight record. Secondarily, the flight records may be sorted by the size of the ISCI GROUP, which may be ascertained by determining the length of the field (i.e., the number of characters), or by any other suitable manner. A tertiary sort of the flight records may be made based on the ITEM NUMBER field, where 1 of N would precede N of N.

Secondary Comparisons

Once the direct matching step discussed above has been performed, a series of secondary comparisons are made for imprecise matches with various parameters. These secondary comparisons are set forth in a preferred order, however it can be appreciated that other orders may be suitable. As above, in the secondary comparisons, previously unassociated (or unmatched) qualified anchor detection records (Type 1) and single-market actual detection records (Type 4) are compared with unassociated (unmatched) multi-market flight information table records and single-market flight information table records, respectively.

Match With a Primary Time Allowance

In one secondary comparison, detection records are compared to unassociated flight records in a manner similar to the manner described above with respect to direct matches. However, in this instance, a predetermined primary time allowance is provided, which has the effect of decreasing the FROM TIME and increasing the TO TIME of the flight record by the primary time allowance. For this comparison, the FROM ALLOWANCE and TO ALLOWANCE fields of the flight record may be employed.

If a match is found in this comparison, the detection record and flight record are associated to one another as described above. Also as above, the FLIGHT MATCHED field of the flight record may be set (e.g., to “1”, “YES”) to indicate that the flight is associated with a detection record, and a FLIGHT PURCHASED field of the flight record may be set (e.g., to 1) to indicate that the detected occurrence of the broadcast advertisement was one of the units indicated in the line item of the buy information.

Match with Wrong ISCI Same Duration

Another secondary comparison can be made in the same manner as described above with respect to a direct match, however, in this instance, a match is made even if the ISCI CODE of the detection record is not within the ISCI GROUP of the flight record, but is of the same AGENCY and CLIENT, and the DURATION of the detection record matches the LENGTH OF SPOT of the flight record.

Match with Wrong ISCI of Wrong Duration

Another secondary comparison can be made in the same manner as described above with respect to a match with a wrong ISCI code, however, in this instance, a match is made if the ISCI CODE of the detection record is not within the ISCI GROUP of the flight record and the DURATION of the detection record is not the same as the DURATION of the flight record.

Match with an Extra Spot

In another secondary comparison, detection records are compared flight records to determine whether the detection record matches a flight record wherein the ITEM NUMBER field of the flight record has the form N of N (e.g., 3 of 3) and the flight record has already been associated with a detection record, which indicates that all the units of the line item of the buy information related to the flight record have already been satisfied. Specifically, detection records are compared to flight records in a manner similar to the direct comparison described above; however, the comparison is made to flight records that have already been associated with a detection record. Further, a match is made if all of the comparisons made with respect to a direct match are true and ITEM NUMBER field of the flight record has the form N of N. In this instance, a match is made with an extra spot.

If an extra spot match is made, then a new flight record is created with the same information as the matched flight record, however a value of “N+1 of N” (e.g., 4 of 3) is placed in the ITEM NUMBER field of the new flight record, to indicate that this is an extra spot. The matching anchor detection record and new flight record are associated to one another, as described above.

In addition, a FLIGHT MATCHED field of the flight record may be set (e.g., to “1”, “YES”) to indicate that the flight is associated with a detection record. Further the FLIGHT PURCHASED field of the flight record may be set (e.g., to 0) to indicate that the detected occurrence of the broadcast advertisement was not one of the units indicated in the related line item of the buy information.

Match with an Extra Spot Using the Primary Time Allowance

Another secondary comparison can be made in the same manner as described with respect to the match with an extra spot, however, in this instance, the predetermined primary time allowance, as described above is permitted.

Match with a Secondary Time Allowance

Another secondary comparison can be made in the same manner as described with respect to the primary time allowance, with a secondary time allowance greater than the first.

Match with Wrong ISCI in an Extra Spot

Another secondary comparison can be made in the same manner as described above with respect to a match with an extra spot, however, in this instance a match is made even if the ISCI CODE of the detection record is not within the ISCI GROUP of the flight record.

Match with Wrong ISCI of Wrong Duration in an Extra Spot

Another secondary comparison can be made in the same manner as described above with respect to a match with an extra spot, however, in this instance a match is made even if the ISCI CODE of the detection record is not within the ISCI GROUP of the flight record and the DURATION of the detection record is not the same as the LENGTH OF SPOT of the flight record.

Discrepancies

A match made during one of the secondary comparisons may be considered a match with a discrepancy. A discrepancy name and/or code may be placed in the flight record to indicate the type of discrepancy. In particular, DISCREPANCY NAME and DISCREPANCY CODE fields of the flight record may be set as follows:

| DISCREPANCY NAME | DISCREPANCY CODE |
|---|---|
| Match with primary time Allow | WITHIN ALLOW |
| Wrong ISCI | WC |
| Wrong ISCI, wrong duration | WC DiffLen |
| Extra Spot | EXTRA SPOT |
| Extra Spot primary allowance | EXTRA SPOT |
| Secondary time allowance | OUTSIDE ALLOW |
| Wrong ISCI, extra spot | WC EXTRA |
| Wrong ISCI, wrong duration, | WC DiffLenExtra |

Step 7—Custom Viewing and Reporting

The result of the detection and matching process is a series of tables which may be queried to produce reports as to fulfilled, unfulfilled and partially fulfilled (erroneous) broadcast orders.

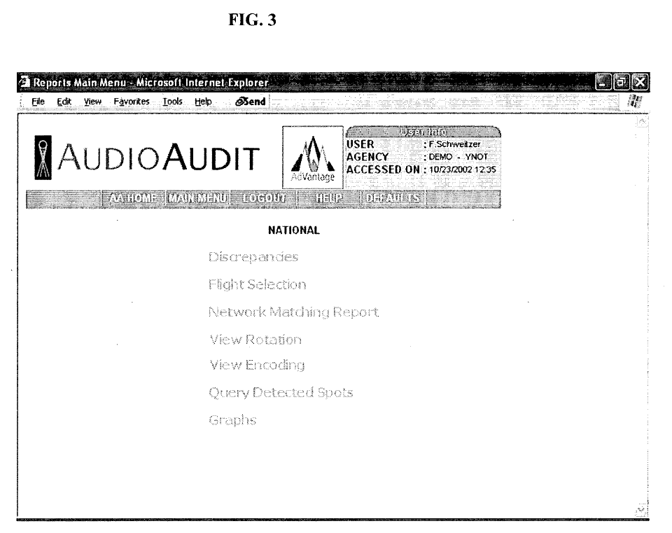

Referring to FIGS. 3-11, the system provides summary and detailed reports on fulfilled and unfulfilled orders, as well as certain types of erroneously fulfilled orders, such as extra spots and wrong advertisements (i.e., wrong creative). The mutual (i.e., two-way) associations between the flight records and the related detection records, and the associates between anchor detection records and related actual detection records provides the ability to provide detailed information as to the bases for the reports. Preferably, the reports include links, such as “View Details” and “Drill Down” that display underlying information in increasing detail.

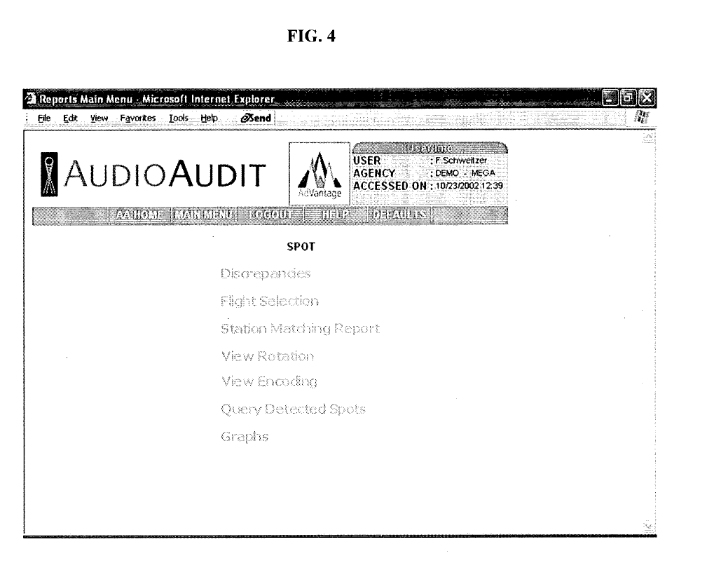

Referring to FIGS. 3 and 4, main screens provide various methods to query information on multi-market (e.g., national) and single-market advertising orders, respectively. Preferably, prior to producing this screen, the user has chosen a particular agency and client combination to query.

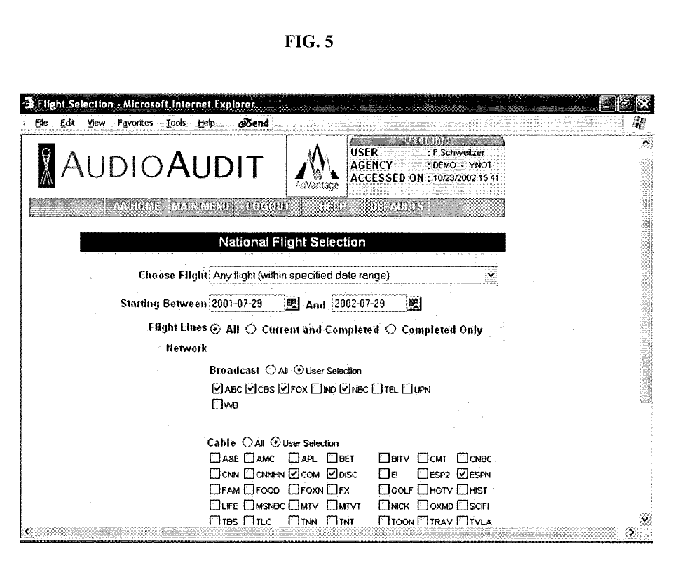

Referring to FIG. 5, a selection screen related to national flight selections provides a means to enter search criteria for obtaining information on specific flight orders, such as the date range and the network.

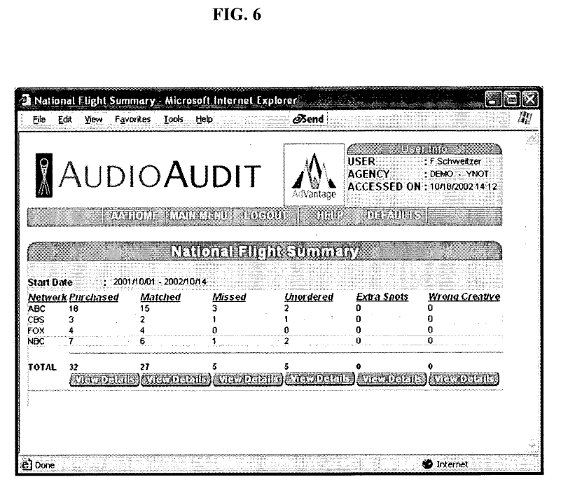

Referring to FIG. 6 search criteria entered in the selection screen of FIG. 5 will produce a National Flight Summary screen which provides summary information regarding the flight within the search criteria. The summary information includes the total number of spots purchased, matched, missed, unordered, extra spots, and wrong creative (i.e., wrong ISCI).

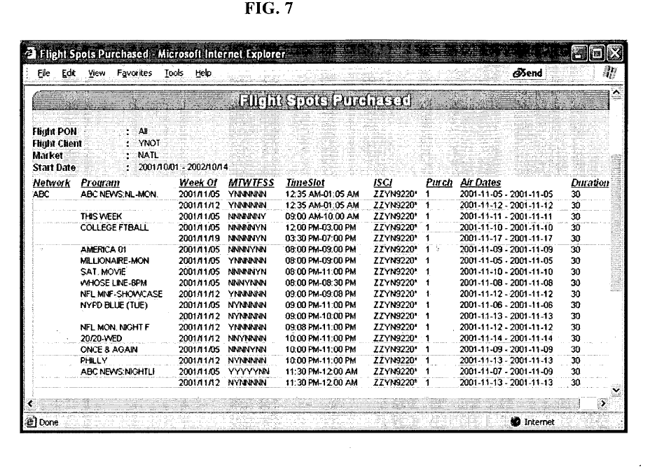

Referring to FIG. 7, selecting the “View Details” button, under the “Purchased” column of the National Flight Summary (FIG. 6) will produce a report of certain details regarding the flight information. This report provides details regarding the spots purchased with the flights display in FIG. 6.

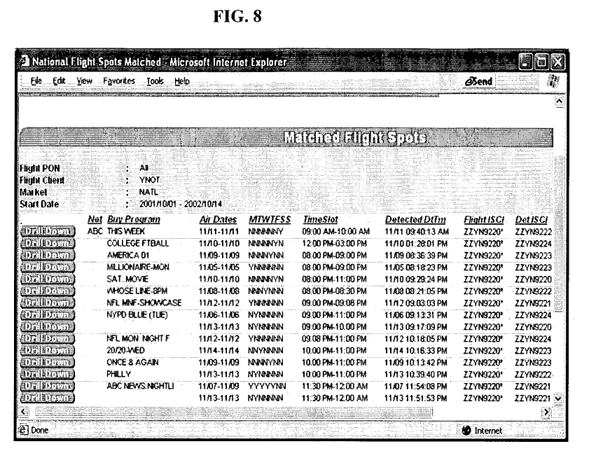

Referring to FIG. 8, selecting the “View Details” button under the “Matched” column of the National Flight Summary (FIG. 6) will produce a report of certain details regarding matched flight information. This report provides details on the anchor detections associated with the flights displayed in FIG. 6.

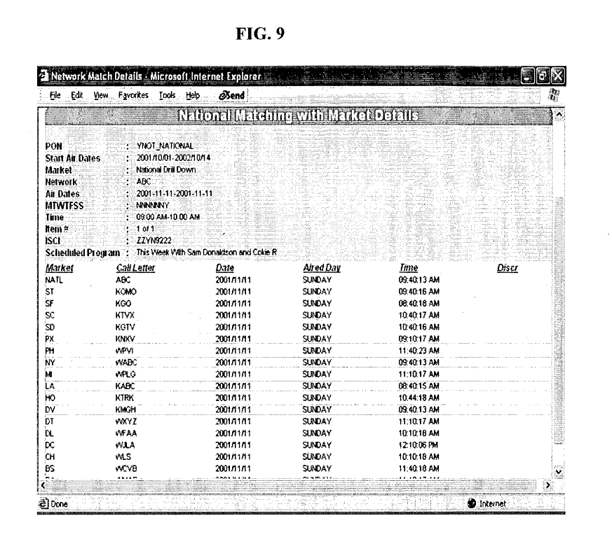

Referring to FIG. 9, further details regarding the actual market detections that are associated with such anchor market detections is available by selecting the associated “Drill Down” button in the report of FIG. 8, which action produces the report of FIG. 9. The report of FIG. 9 provides detailed information regarding individual actual market detections that comprise the associated anchor market detection.

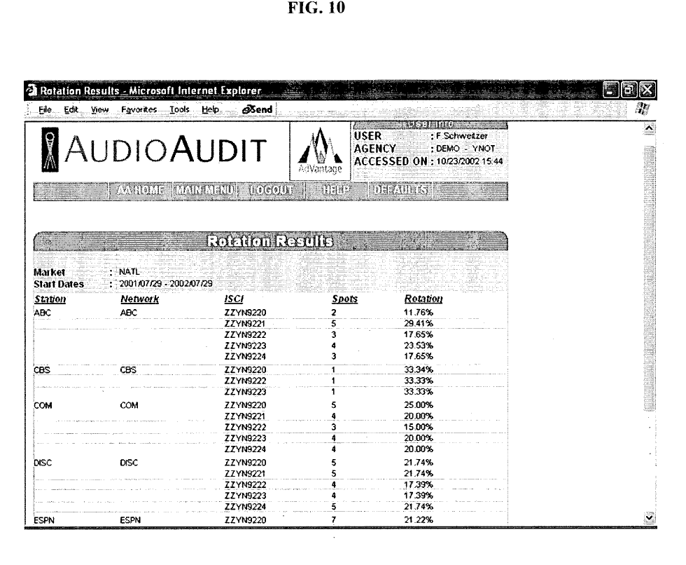

Referring to FIG. 10, the system also provides reports regarding the rotation of certain advertisements, based on the ISCI CODE.

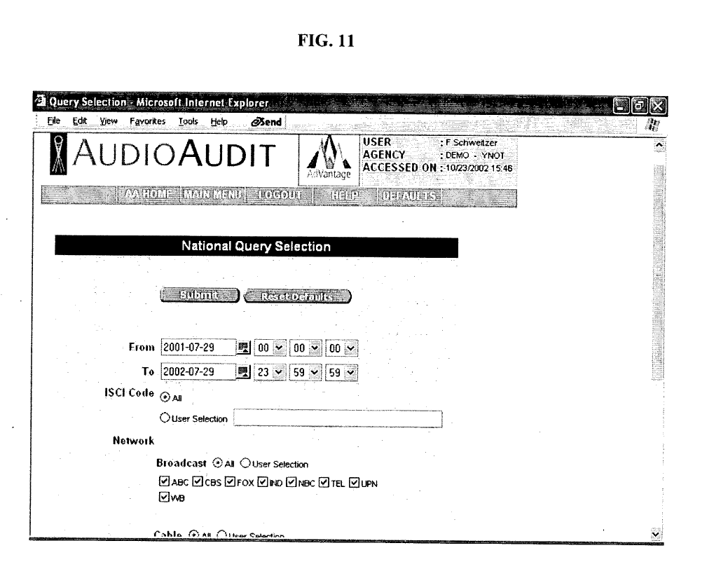

Referring to FIG. 11, the system also provides the user with the ability to perform ad hoc queries of the detection records based on, for example, the date range, ISICI code(s), and call letters.

Therefore, as can be appreciated the present invention provides a method and system for tracking, managing multi-market broadcast advertising that provide accurate, independent confirmations of the fulfillment of broadcast advertising orders, that provide significant advantages in matching multi-market broadcasts of advertisements to multi-market advertising orders, that provide significant advantages in reporting of fulfilled and unfulfilled orders and that provide such matching, confirmation and reporting for a large number of broadcasts over a large number of broadcast markets.

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

What is claimed:

1. A method of analyzing multi-market broadcasts of commercial advertisements, comprising:
assigning unique identifiers to a plurality of commercial advertisements;
recording information regarding said plurality of commercial advertisements and said respective unique identifiers in a computer database;
receiving electronic detections of a plurality of actual market-broadcast instances of a commercial advertisement, said plurality of actual market-broadcast instances comprising a plurality of broadcast markets;
recording information regarding said detections in a computer database;
associating related ones of said plurality of actual market-broadcast instances of said commercial advertisement in a computer database, said related ones of said actual market-broadcast instances comprising a plurality of broadcast markets and being related to a common featured program broadcast in said plurality of broadcast markets;
recording information regarding a plurality of multi-market broadcast orders of commercial advertisements in a computer database; and
associating said associated related actual market-broadcast instances of said commercial advertisement with a related multi-market broadcast order for said commercial advertisement in a computer database, said multi-market broadcast order comprising said plurality of broadcast markets.
